(19) United States
(12) Patent Application Publication
(10) Pub. No.: US 2018/0326670 A1
(43) Pub. Date: Nov. 15, 2018

(54) Heater

(71) Applicant: ROPEX Industrie-Elektronik GmbH, Bietigheim-Bissingen (DE)

(72) Inventors: Robert Peters, Bietigheim-Bissingen (DE); Alexander Hupp, Sulzfeld (DE)

(21) Appl. No.: 15/593,831

(22) Filed: May 12, 2017

(51) Int. Cl. B29C 65/02; B29C 65/00

(52) U.S. Cl. CPC B29C 65/02; B29L 2031/18; B29C 66/0244

(57) ABSTRACT

A heating device for thermal joining of plastic materials having a base body, which is penetrated by a cooling recess and on which an electrically insulating support surface is configured, on which at least one electrically conductive heat conductor is arranged, which is provided with an electrically insulating coating on a contact surface facing away from the support surface. The support surface has at least one curved or angled support surface section and that the heat conductor overlaps the curved or angled support surface section at least in parts.

The invention relates to a heating device for thermal joining of plastic materials, having a base body, which is penetrated by a cooling recess and on which an electrically insulating support surface is configured, on which at least one electrically conductive heat conductor is arranged, which is provided with an electrically insulating coating on a contact surface facing away from the support surface.

A heating device for appliances used for thermal processing of plastic sheets having a metal substrate assigned to a cooling device is known from DE 197 37 471 C2, wherein an electrically insulating layer is applied to the substrate onto which at least one thick layer conducting strip is applied as heat conductor.

The object of the invention consists in providing a heating device which can be used to improve the quality of the plastic welded joints to be produced using the heating device.

This object is achieved for a heating device of the type mentioned herein above having the features of claim 1. Provision is made here that the support surface has at least one curved or angled support surface section and that the heat conductor overlaps the curved or angled support surface section at least in parts.

In the process, the curved or angled support surface section and the assigned heat conductor form a three-dimensional contoured projection or a three-dimensional contoured indentation on or in the plastic material to be welded depending on the run of the curve or the angle. A path of a welded or sealed joint co-determined by the geometry of the heat conductor, which can be produced on a plastic material configured as a plastic sheet, for example, with the help of the heating device and a correspondingly configured pressing device, runs in a heat conductor plane in the case of a simpler configuration of the heating device, which in a departure from the prior art, is not congruent with a support surface plane defined by outer edges of the support surface. Preferably, the welded or sealed joint runs along a three-dimensional path. Provision can be made, for example, that the support surface and the heat conductor are arranged predominantly in the support surface plane defined by outer edges of the support surface and only leave the support surface plane locally. Preferably, the support surface plane also corresponds to a locking plane for a welding or sealing tool defined from the heating device and the pressing device.

Advantageous developments of the invention are the subject-matter of the sub-claims.

It is useful if the electrically insulating support surface is defined by a ceramic coating which is applied to a pressing surface configured on the base body. The pressing surface is the surface on the base body which corresponds to a contact surface, which, for its part, comes into contact with the plastic material to be processed during a welding or sealing procedure. The contact surface can also be called the working surface of the heating device and is defined substantially by the support surface, the heat conductor applied thereon and by the electrical insulation for the heat conductor facing away from the support surface, as well as a non-stick coating, configured to cover a large surface area if required. The ceramic coating on the pressing surface, the surface opposite the pressing surface of which forms the support surface, guarantees reliable electrical insulation for the heat conductor applied to the support surface compared with the pressing surface of the base body even if the coating is thin. Moreover, the ceramic coating acts as an advantageous thermal coupling between the heat conductor and the base body, such that once the flow of electricity to the heat conductor has ended, the heat energy from the plastic part to be processed as well as from the heat conductor can be conducted particularly quickly through the ceramic coating to the base body, where, with the help of a fluid flow, in particular flow of liquid, through the cooling recess, further heat dissipation takes place. This results in rapid cooling and an associated hardening of the sealed or welded joint region on the plastic part. The ceramic coating can be configured preferably as ceramic glass, in particular with a layer thickness of 10/1000 mm to 400/1000 mm.

Provision is made in an advantageous development of the invention that a wall thickness of the base body between the cooling recess and the pressing surface below the electrically insulating support surface is constant. This guarantees that heat dissipation between the pressing surface and a cooling fluid collected in the cooling recess, in particular flowing through the cooling recess, is at least virtually identical in every region of the pressing surface. This represents a particular advantage if the curves and/or angles provided on the support surface do not lead to local heat concentrations in the welded or sealed joint owing to their geometries. If the wall thickness is constant in the base body between the cooling recess and the pressing surface, provision can be made that the surface geometry of the support surface and the course of the heat conductor are realised through locally different wall thicknesses of the ceramic coating. Provision is made, for example, that the base body is produced from a metal profile with a constant cross-section and that the ceramic coating is applied to the pressing surface with locally different layer thicknesses. Alternatively, provision can be made that the surface geometry of the support surface is already configured on the base body, wherein here both the pressing surface and an inner surface in the cooling recess opposite the pressing surface have at least geometrical similarities, in particular are geometrically similar. Provision is made in an embodiment of the base body from a ceramic material that an inner surface in the cooling recess opposite the pressing surface and the pressing surface, which in particular must be equated with the support surface, have at least geometrical similarities, in particular are geometrically similar. Consequently, in spite of the contoured surface, the same wall thickness between the cooling recess and the pressing surface (or in this case also the support surface) can always be achieved over the entire support surface.

Provision is made in a further embodiment of the invention that a first wall thickness of the base body between the cooling recess and the pressing surface below a concave support surface section is configured to be less than a second wall thickness of the base body between the cooling recess and the pressing surface below a flat or convex support surface section. Account is taken in the case of such a profile of the wall thickness of the base body that a higher energy density occurs in concave support surface sections during the welding or sealing process, which cannot, however, lead to overheating of the plastic material to be processed. This is prevented by the fact that improved heat dissipation through the base body into the cooling fluid is guaranteed in such areas by means of the reduced wall thickness.

Preferably provision is made that a neutral axis of the heat conductor has a spatial design that can be preset and/or that the pressing surface has a surface geometry corresponding to, preferably geometrically similar to, a spatial design of a neutral axis of the heat conductor. A polyline extending along the heat conductor, which is always arranged inside a cross-section of the heat conductor and which, in the case of deformation of the heat conductor, experiences no or only minimal tensile or compression stresses, should be understood as the neutral axis. The neutral axis can be defined using elasto-kinematic analysis methods, both if the heat conductor is made from a strip material, which is applied to the support surface in a laminating process, for example, and if the heat conductor is produced using a method where an electrically conductive, amorphous material is applied to the support surface, and serves here to describe the course of the heat conductor. Said neutral axis or zero line extends in all spatial directions of a Cartesian coordinate system in the heat conductor according to the invention.

It is advantageous if a layer thickness of the ceramic coating, which is applied to the pressing surface, is constant.

This enables easy production of the ceramic coating, for example by applying a ready-made, ceramic glass raw material layer, in particular applied to a flexible support material, which layer is then heated in a subsequent production step such that it creates a positively bonded connection with the pressing surface and forms the support surface.

It is useful if the pressing surface is configured flat and if a layer thickness of the ceramic coating, which is applied to the flat pressing surface, is configured as variable in order to form the at least one curved support surface section. This enables a simple and cost-effective design of the base body, wherein the surface geometry for the contact surface of the heating device is defined by a layer thickness distribution of the ceramic coating in combination with the heat conductor applied thereon, the insulation for the heat conductor and a non-stick coating provided where appropriate.

Provision is made in a further embodiment of the invention that the heat conductor is spatially configured such that in one spatial direction in which a cross-sectional extent of the heat conductor is minimal, it extends between two planes aligned parallel to each other, the distance between which is greater than the cross-sectional extent in said spatial direction. Here, the cross-sectional extent is a distance between opposite external surfaces of the heat conductor. For example, a minimal cross-sectional extent of a heat conductor configured with a rectangular cross-section corresponds to the length of a shorter edge of the rectangular cross-section. Owing to its spatial design, the heat conductor extends in the spatial direction in which the cross-sectional extent is minimal, between two parallel planes, the distance between which is greater than the minimal cross-sectional extent.

Provision is made preferably that the heat conductor is spatially configured such that in a spatial direction, in which a cross-sectional extent of the heat conductor is maximal, it extends between two planes aligned parallel to each other, the distance between which is greater that the cross-sectional extent in said spatial direction.

Provision is made in a further embodiment of the invention that the heat conductor has different cross-sections in cross-sectional planes, which are aligned at right angles to a neutral axis of the heat conductor. Sections are created along the neutral axis of the heat conductor as a result, which have different electrical resistances, thus allowing the temperature distribution along the heat conductor to be influenced, for example. Alternatively, volatile or constant cross-section changes can be provided for the heat conductor.

Advantageous embodiments of the invention are shown in the drawings.

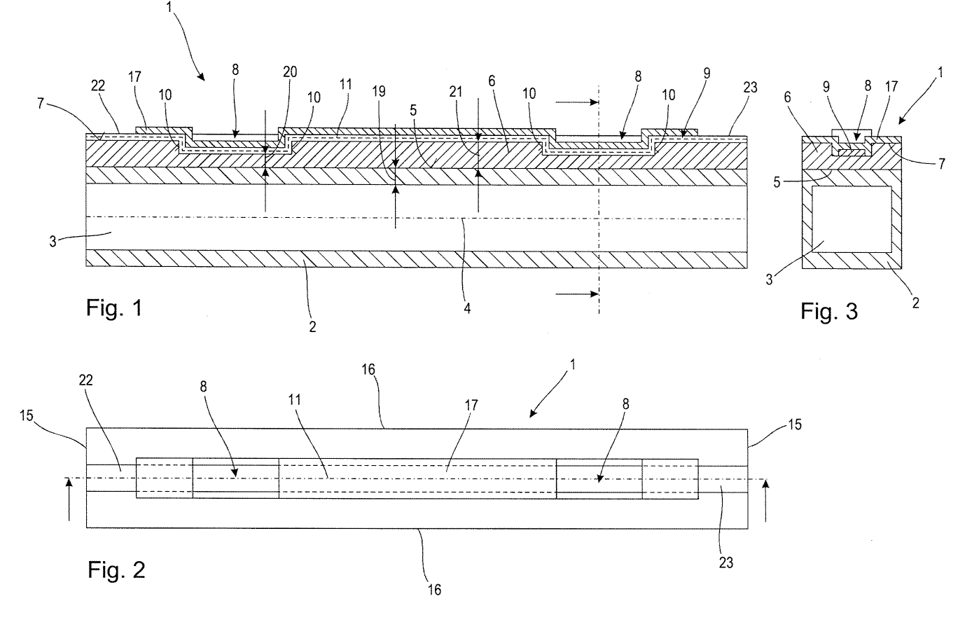

FIG. 1 shows a purely schematic, cut-away front view (not to scale) of a first embodiment of a heating device,

FIG. 2 shows a top view of the heating device according to FIG. 1,

FIG. 3 shows a side view of the heating device according to FIG. 1,

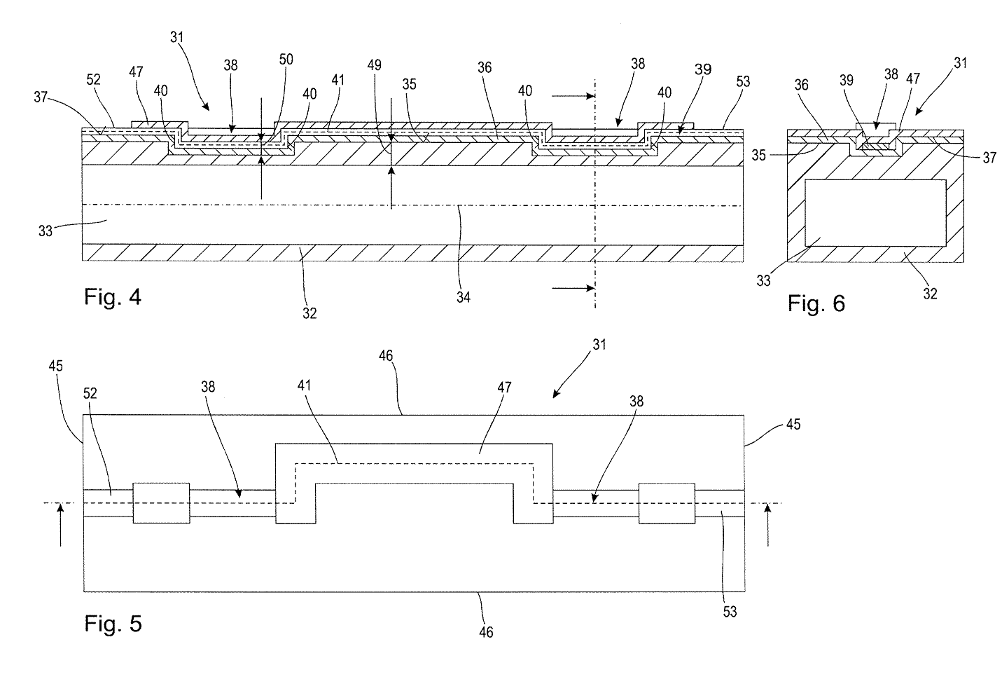

FIG. 4 shows a purely schematic (not to scale), cut-away front view of a second embodiment of a heating device,

FIG. 5 shows a top view of the heating device according to FIG. 4, and

FIG. 6 shows a side view of the heating device according to FIG. 4.

A first embodiment of a heating device 2 shown in FIGS. 1 to 3 is provided for use with a pressing device (not shown) for forming a welding or sealing tool and can be employed, for example, in an electrically driven welding or sealing machine (also not shown), in particular for positively bonded, thermal joining of open end regions of plastic sleeves to plastic bags.

For this purpose, the heating device 1 comprises a base body 2, which can be configured in the form of a rectangular profile and which comprises a cooling recess 3. For illustration purposes only, provision is made that the base body 2, in cross-sectional planes, which are aligned at right angles to a profile axis 4, has the same cross-section over the entire length thereof. Furthermore, provision is made for example that cross-sections of an external geometry of the base body 2 and the cooling recess 3 are each configured as rectangular. Preferably, the base body 2 is made of metal, in particular aluminium or a ceramic material.

A ceramic coating 6 is applied to an external surface of the base body 2, also called the pressing surface 5, which is attached in a positively bonded manner to the pressing surface 5 and which is a ceramic glass layer in particular. Together with an outer side facing away from the pressing surface 5, the ceramic coating 6 defines a support surface 7, which, for illustration purposes only, is configured as a plane with two rectangular sunken recesses 8. A strip-shaped heat conductor 9 is applied to the support surface 7. The heat conductor 9 can be made from a metallic strip material, for example, which is attached to the support surface 7 in a positively bonded manner, for example by soldering, or the heat conductor 9 is applied to the support surface 7 using a suitable method from an electrically conductive amorphous material, which can contain metal particles in a thermosetting binder for example, and hardens there.

Due to the recesses 8 introduced into the plane, the support surface 7 has a plurality of, for illustration purposes only, angled support surface sections 10, which according to the illustrations in FIGS. 1 to 3, are at least partly covered by the heat conductor 9.

Thus, the heat conductor 9 has a spatial design in which a neutral axis 11 lies in the sectional plane of FIG. 1, which can therefore also be called the heat conductor plane. For illustration purposes only, the heat conductor plane is aligned at right angles to a support surface plane (not shown in detail) defined by outer edges 15, 16 of the support surface 7 and can, for example, comprise the intersecting line 18 plotted in FIG. 2 and at the same time be aligned at right angles to the representation plane of FIG. 2.

As can be seen from the illustration in FIG. 1, the neutral axis 11 presented in a schematic manner is created by a sequence of linear sections aligned at right angles to each other and, according to the illustration in FIG. 1, follows the course of the support surface 7 in a geometrically similar way. As can also be seen from FIG. 1, a wall thickness 19 between the cooling recess 3 and the pressing surface 5 is configured as constant, whereby the base body 2 has a simple design. The geometry of the support surface 7 and of the heat conductor 9 applied to the support surface 7 is defined by layer thicknesses 20, 21 of the ceramic coating 6 that are different in sections for illustration purposes only.

Furthermore, provision is made for illustration purposes only that the heat conductor 9 has the same cross-section in cross-sectional planes (not shown), which are aligned at right angles to the neutral axis 11, which does not necessarily have to be the case in other embodiments of heat conductors (not shown). In fact, the heat conductor can have varying cross-sections along the neutral axis as well as along its course.

The support surface 7 and the heat conductor 9 are covered by an insulating layer 17, which firstly guarantees electrical insulation for the heat conductor 9 and secondly, can be configured preferably as a non-stick coating or with an additional non-stick coating. Provision is made, for illustration purposes only, that the insulating layer 17 has the same layer thickness on the unspecified, flat surfaces of the support surface 7 and of the heat conductor 9, and preferably high thermal conductivity. The insulating layer 17 ends respectively at a distance from the shorter outer edge 15 of the support surface 7, whereby connecting surfaces 22, 23 of the heat conductor 9 remain free, on which a supply of electrical energy to the heat conductor 9 is made possible. For illustration purposes only, the insulating layer 17 is configured as a ceramic glass layer.

When electrical energy is supplied to both connecting surfaces 22, 23 of the heat conductor 9, an electrical current flows through the latter, which results in a heating of the heat conductor 9. The heat provided by the heat conductor 9 can be delivered through the electrically insulating layer 17 to a plastic material (not shown in detail) in order to enable local plasticisation and a welding together of several layers of the plastic material. The supply of electrical energy to the heat conductor 9 is then switched off and consequently the latter provides no further heat. In fact, heat is transferred from the plastic material (not shown) via the insulating layer 17, the heat conductor 9, the ceramic coating 6 and the base body 2 into the cooling fluid that has collected in the cooling recess 3. The plastic material can be cooled quickly as a result.

Reference signs increased by 30 respectively are used in the second embodiment of a heating device 31 shown in FIGS. 4 to 6 for those components that have the same functions as heating device 1 and a further description of said components is dispensed with.

In the illustration in FIG. 4, the cutting line follows the neutral axis 41 of the heat conductor 39, as shown in FIG. 5.

Unlike in the heating device 1, provision is made in the heating device 31 that a wall thickness 49 of the base body 32 between a cooling recess 33 and an outer surface called a pressing surface 35 is configured as variable, whereas a layer thickness 50 of the ceramic coating 36 applied to the pressing surface 35 is constant. This guarantees a particularly advantageous cooling effect by the cooling fluid collected, in particular flowing into the cooling recess 33, in the region of the recesses 38 in the support surface 37, in which particularly high energy density occurs owing to the angled course of the heat conductor 39 as well as the concave indentation caused by the recesses 38.

As can be seen from FIGS. 4 and 5, the neutral axis 41 of the heat conductor 39 runs along a three-dimensional joint path since the heat conductor 39 is angled in all three spatial directions of a Cartesian coordinate system.

1. A heating device for thermal joining of plastic materials having a base body, which is penetrated by a cooling recess and on which an electrically insulating support surface is configured, on which at least one electrically conductive heat conductor is arranged, which is provided with an electrically insulating coating on a contact surface facing away from the support surface, wherein the support surface has at least one curved or angled support surface section and wherein the heat conductor overlaps the curved or angled support surface section at least in parts.

2. The heating device according to claim 1, wherein the electrically insulating support surface is defined by a ceramic coating, which is applied to a pressing surface configured on the base body.

3. The heating device according to claim 2, wherein a wall thickness of the base body between the cooling recess and the pressing surface below the electrically insulating support surface is constant.

4. The heating device according to claim 2, wherein a first wall thickness of the base body between the cooling recess and the pressing surface below a concave support surface section is configured to be less than a second wall thickness of the base body between the cooling recess and the pressing surface below a flat or convex support surface section.

5. The heating device according to claim 2, wherein a neutral axis of the heat conductor has a spatial design that can be preset and/or wherein the pressing surface has a surface geometry corresponding to a spatial design of a neutral axis of the heat conductor.

6. The heating device according to claim 5, wherein a layer thickness of the ceramic coating, which is applied to the pressing surface, is constant.

7. The heating device according to claim 2, wherein the pressing surface is configured as flat and wherein a layer thickness of the ceramic coating, which is applied to the flat pressing surface, is configured as variable in order to create the at least one curved support surface section.

8. The heating device according to claim 1, wherein the heat conductor is configured spatially such that it extends in a spatial direction in which a cross-sectional extent of the heat conductor is minimal, between two planes aligned parallel to each other, the distance between which is greater than the cross-sectional extent in said spatial direction.

9. The heating device according to claim 1, wherein the heat conductor is configured spatially such that it extends in a spatial direction in which a cross-sectional extent of the heat conductor is maximal, between two planes aligned parallel to each other, the distance between which is greater than the cross-sectional extent in said spatial direction.

10. The heating device according to claim 1, wherein the heat conductor has different cross-sections in cross-sectional planes, which are aligned at right angles to a neutral axis of the heat conductor.

11. The heating device according to claim 5, wherein the pressing surface has a surface geometry geometrically similar to a spatial design of the neutral axis of the heat conductor.
